(19) United States
(12) Patent Application Publication
(10) Pub. No.: US 2003/0061105 A1
(43) Pub. Date: Mar. 27, 2003

(54) On-line distribution of music related items

(76) Inventors: April J. Morris, Anaheim, CA (US); David Davidson, Johnston, IA (US); Steve Edgerton, West Des Moines, IA (US); Lance Lyda, Hurst, TX (US)

Correspondence Address: Joseph W. Bain, Akerman, Senterfitt & Eidson, P.A., 222 Lakeview Avenue, Fourth Floor, P.O. Box 3188, West Palm Beach, FL, 33402-3188, US

(21) Appl. No.: 09/837,753

(22) Filed: Apr. 17, 2001

Related U.S. Application Data
(60) Provisional application No. 60/198,095, filed on Apr. 17, 2000.

(51) Int. Cl. G06F 17/60

(52) U.S. Cl. 705/26

(57) ABSTRACT

A method for on-line distribution of music related items can efficiently distribute music related items to a consumer over a computer communications network according to the musical profile of the consumer. The method can include several steps beginning with the step of identifying a musical profile of a consumer in a first interactive hypermedia document. Notably, the identifying step can include classifying the consumer according to any number of permutations of age group, instrument played, skill level and preferred music type. Moreover, the identifying step can include the further step of classifying the consumer according to type of music related item. Responsive to the identification of the music profile of the consumer, the method can list in a second interactive hypermedia document music related items consonant with the identified musical profile. Subsequently, the method of the invention can accept in the second interactive hypermedia document a user selection of at least one of the music related items. Finally, the method of the invention can include the step of consummating a purchase of the selected music related items. In the preferred embodiment, the consummating step of the invention can comprise several steps including accepting a consumer selection for downloading selected music related items to a client, identifying a target location in the client for downloading selected music related items, and transmitting the selected music related items to the target location in the client. Significantly, the client can be a network-enabled electronic musical instrument.

### CROSS REFERENCE TO RELATED APPLICATIONS

This application claims the benefit of United States Provisional Application Serial No. 60/198,095, filed Apr. 17, 2000.

### STATEMENT REGARDING FEDERALLY SPONSORED RESEARCH OR DEVELOPMENT

(Not Applicable)

### BACKGROUND OF THE INVENTION

1. Technical Field

This invention relates to the field of music distribution systems and more particularly to a system and method for on-line distribution of music related items.

2. Description of the Related Art

The internet is a set of globally interconnected computers through which multiple users access data and programs from around the world. As an informational sharing mechanism, it comprises a network of networks for interconnecting a plurality of server computers (servers) and a plurality of client computers (clients). The Internet permits a wide variety of communication and informational retrieval mechanisms, including electronic mail (e-mail), File Transfer Protocol (FTP), USENET, and the World Wide Web (Web). Notably, the Web permits users to retrieve and view hypertext document containing not only text, but also pictures, sound, animated images, and video-clips. Moreover, the Web permits users to interact with retrieved hypertext documents.

The Web primarily consists of Web servers and Web browsers. Whereas a Web server hosts hypertext documents, known as Web pages, by storing the Web pages and transmitting those Web pages on command, a Web browser resides on a client computer, and both supplies requests to Web servers for Web pages and displays the retrieved Web pages in a user interface. Each Web page stored in a Web server has associated therewith a Uniform Resource Locator (URL) identifying both a particular domain on the Internet in which the Web server can be located and a location in the Web server where the Web page is stored. The URL permits any given Web page to be distinguished from all other Web pages.

Companies utilize the Web in order to operate virtual stores for conducting electronic commerce (e-commerce). As in more traditional, brick and mortar operation, virtual stores permit a consumer to browse the virtual store, to identify products desired for purchase, and to consummate the purchase of those identified products at the conclusion of browsing the store. By establishing an e-commerce storefront, a company can provide to the consumer the ability to shop for desired products from the comfort of the consumer's home without subjecting the consumer to the sales pressures and time expense of visiting a traditional brick and mortar store.

In operation, virtual stores can exist as a collection of hypermedia documents, for example Web pages which can either be dynamically generated by a Web server or statically created by a programmer and stored in a Web server. A collection of products can be listed in the Web pages which can be transmitted on demand to client computers operated by consumers. Notably, the listed products can be activated hyperlinks to other Web pages stored in the Web server which can contain further information regarding a selected product. Ultimately, the consumer can select items for purchase by clicking on a hyperlink indicating the same. Each time the consumer selects a product for purchase, the product can be placed in a virtual shopping cart.

When the consumer is ready to “check out”, the virtual shopping cart can be subjected to an electronic check out method. The electronic check out method can iterate through the shopping cart and provide to the consumer a total price required to purchase the goods selected for purchase in the shopping cart. The consumer can provide relevant payment and shipping information and can consummate the purchase. Additionally, in the context of the on-line purchase of software, at the consumer's option, some virtual stores permit the consumer to download the purchased software from the Web server or other communicatively linked server to the consumer's computer rather than having the software shipped to the consumer's home.

Many virtual stores have extended the model for the on-line shopping experience by providing to the consumer an on-line shopping tool. The on-line shopping tool can facilitate the shopping experience by filtering the products available for purchase according to desired product characteristics. For example, in the software context, products can be filtered according to the product type, product target platform and product cost. Similarly, in regard to the on-line purchase of automobiles, the inventory of products available for purchase can be filtered according to automobile make, model, price range, number of doors, color, etc.

The present on-line shopping model, however, is inadequate in the context of on-line shopping for music related items. Specifically, the selection of music related items often is dependent on the characteristics of the consumer rather than the characteristics of the product itself. For instance, in relation to the selection and purchase of instructional software for instructing individuals in the playing of a musical instrument, the consumer selects the product according to the type of instrument played by the consumer and the consumer's skill level in playing the instrument. Similarly, the consumer selects MIDI tracks for use in an electronic musical instrument according to the consumer's preference for a music style, for example Jazz or Hip Hop.

Finally, many consumers of music related items also own electronic musical instruments. Though electronic musical instruments can take many different forms, typically, an electronic musical instrument can include a music interface, for instance a keyboard or guitar strings, a music processor for processing music signals generated by the music interface, and output means for audibly presenting the processed music signals to a user. An example of an electronic musical instrument can include the Philharmonic® manufactured by Van Koevering Company, Inc. of Des Moines, Iowa and the Interactive Piano® also manufactured by Van Koevering. Notably, the Philharmonic, Interactive Piano and other electronic musical instruments can contain connectivity means, for example a modem, for communicatively connecting the electronic musical instrument to a server over a computer communications network. Moreover, the Philharmonic, Interactive Piano, as well as other electronic musical instruments, can contain fixed storage for storing computer programs directly in the electronic musical instrument.

Notwithstanding, presently, in order to install music related software in an electronic musical instrument, a user first is required to obtain the software embodied in a portable medium, for instance a CD-ROM or floppy disk. Subsequently, the user can install the software in the musical instrument by physically inserting the portable medium into the electronic musical instrument. However, presently, owners of an electronic musical instrument cannot electronically purchase software for an electronic musical instrument at a music software e-commerce site and subsequently download the software directly into the electronic musical instrument.

Thus, by not providing a suitable on-line shopping model for operating a virtual store distributing music related items, present e-commerce systems fail to adequately facilitate the on-line purchase of music related items. Moreover, by not providing a suitable facility for downloading purchased music related software directly into a personal computer or electronic musical instrument, present e-commerce systems fail to capitalize on present advances in network-enabled electronic musical instruments.

### SUMMARY OF THE INVENTION

A method for on-line distribution of music related items can efficiently distribute music related items to a consumer over a computer communications network according to the musical profile of the consumer. The method can include several steps beginning with the step of identifying a musical profile of a consumer in a first interactive hypermedia document. The identifying step can include classifying the consumer according to age and instrument played. Alternatively, the identifying step can include the step of classifying the consumer according to age and skill level. In yet another alternative embodiment, the identifying step can include the step of classifying the consumer according to age and preferred music type.

Notably, the identifying step can include classifying the consumer according to any number of permutations of age group, instrument played, skill level and preferred music type. Moreover, the identifying step can include the further step of classifying the consumer according to type of music related item. In a preferred embodiment, the identifying step comprises the steps of: transmitting the first interactive hypermedia document from a server to a client; accepting in the client a consumer selection in the first interactive hypermedia document; and, posting the selection from the client to the server. Furthermore, the posting step comprises the step of including the selection in a hypertext transfer protocol response.

Responsive to the identification of the music profile of the consumer, the method can list in a second interactive hypermedia document music related items consonant with the identified musical profile. Subsequently, the method of the invention can accept in the second interactive hypermedia document a user selection of at least one of the music related items. Finally, the method of the invention can include the step of consummating a purchase of the selected music related items.

In a preferred embodiment, the listing step can include several steps. First, a query statement can be generated for a database of music related items.

Significantly, the query statement can be generated using the identified musical profile. Second, an electronic query of the database can be performed using the query statement. Third, a result set can be retrieved from the database. The result set can contain a listing of at least one music related item filtered from the database using the query statement. Fourth, each listing in the result set can be inserted in the second interactive hypermedia document. Each listing can be hyperlinked to a hypermedia document further describing the music related item. Finally, the second hypermedia document can be transmitted from the server to the client.

Responsive to the user selection of at least one music related item in the second interactive hypermedia document, the method can further include the steps of providing a third interactive hypermedia document further describing the music related item; and, accepting in the third interactive hypermedia document a user command for purchasing the music related items. Additionally, the third interactive hypermedia document can contain a hyperlink to a fourth interactive hypermedia document for displaying detailed information describing the at least one music related item.

In the preferred embodiment, the consummating step of the invention can comprise several steps. First, a consumer selection for downloading selected music related items to the client can be accepted. Second, a target location can be identified in the client for downloading selected music related items. Finally, the selected music related items can be transmitted to the target location in the client. Significantly, the client can be a network-enabled electronic musical instrument.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a pictorial representation of a network enabled electronic musical instrument connected to a server in a computer communications network.

FIG. 2 is a schematic diagram of a network enabled electronic musical instrument for use in the present invention.

FIGS. 3A-3F are screen shots illustrating various hypermedia documents used in a method for on-line distribution of music related items.

FIG. 4 is a flow chart illustrating a method for on-line distribution of music related items.

### DETAILED DESCRIPTION OF THE INVENTION

A method for on-line distribution of music related items can efficiently distribute music related items to a consumer over a computer communications network according to the musical profile of the consumer. The method can include several steps including identifying a musical profile of a consumer in a first interactive hypermedia document. Notably, the identifying step can include classifying the consumer according to any number of permutations of age group, instrument played, skill level and preferred music type. Moreover, the identifying step can include the further step of classifying the consumer according to type of music related item. Responsive to the identification of the music profile of the consumer, the method can list in a second interactive hypermedia document music related items consonant with the identified musical profile. Subsequently, the method of the invention can accept in the second interactive hypermedia document a user selection of at least one of the music related items. Finally, the method of the invention can include the step of consummating a purchase of the selected music related items.

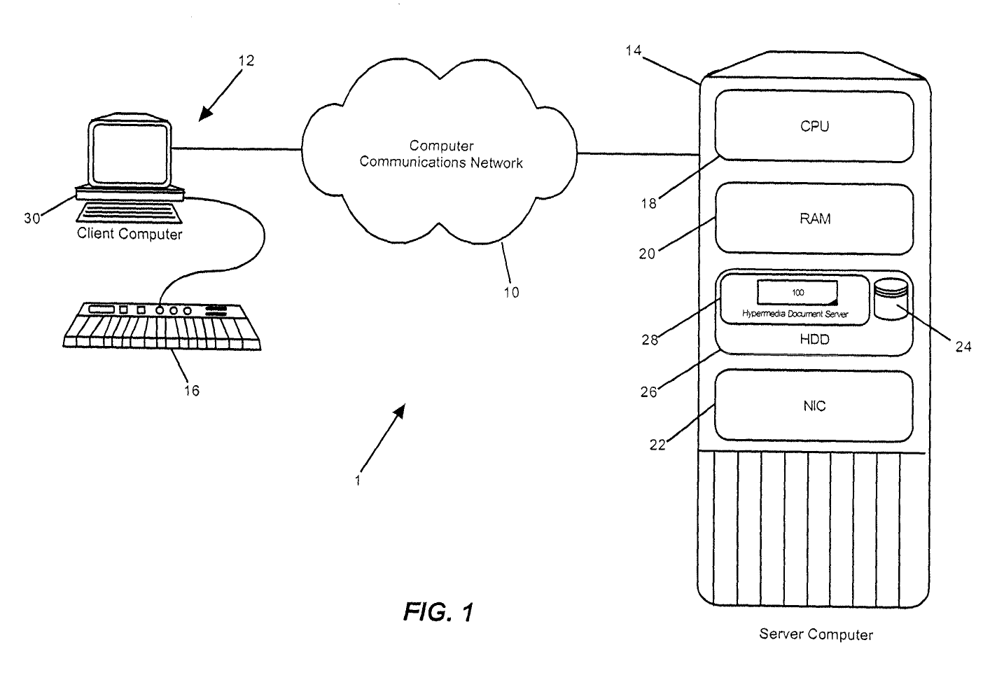

Referring now to FIG. 1, a typical on-line environment 1 is illustrated in which the method of the present invention can be practiced. This on-line environment 1 comprises a computer communications network 10 interconnecting client computers 12 and server computers 14, although only a single client 1 2 and a single server 14 are shown in the figure for ease of illustration. Typically, however, the on-line environment 1 0 could potentially comprise millions of clients and servers 14. Notably, the client 12 is shown as an electronic musical instrument comprising both a music processing computer 30 and a music interface shown as a keyboard 16.

The computer communications network 10 can be any non-publically accessible network such as a LAN (local area network) or WAN (wide area network), or preferably, the Internet. The interconnections between the servers 14 and clients 12 can be thought of as virtual circuits that are established between the servers 14 and the clients 1 2 for the express purpose of communication. Each client 12 can establish a connection with a server 14 in order to transmit a request for a document stored in the server 14 via the computer communications network 10. Typically, the document can be a hypermedia document, for instance a Web page. Servers 1 4 can accept connections from clients 1 2 in order to service transmitted requests for documents. Additionally, servers 14 can service transmitted requests by sending responses back to the requesting clients 1 2 via the computer communications network 10.

Typically, a response can be a document, for example a requested Web page. However, the invention is not limited in this regard. Rather, the response can be a notification to the requesting client 12 on the status of the request, for example “HTTP 404-Not Found”. Additionally, the response is not limited to a document, but the response can be any requested information, for example an audio clip. Notably, servers 14 or clients 12, alone, can function as both a server 1 4 and a client 12. Hence, the use of these terms in the remainder of the foregoing specification are intended to refer only to the role being performed relative to a particular connection, not to either's capabilities in general.

As shown in FIG. 1, each server 14 preferably comprises a computer having therein a central processing unit (CPU) 18, an internal memory device 20 such as a random access memory (RAM), and a fixed storage 26 such as a hard disk drive (HDD). The server 14 also includes network interface circuitry (NIC) 22 for communicatively connecting the server 14 to the computer communications network 10. Optionally, the server 14 can further include a keyboard (not shown) and at least one user interface display unit (not shown) such as a video display terminal (VDT) operatively connected thereto for the purpose of interacting with the server 14. However, the invention is not limited in this regard. Rather, the server 14 requires neither a keyboard nor a VDT in order to suitably operate according to the inventive arrangements.

The CPU 18 can comprise any suitable microprocessor or other electronic processing unit, as is well known to those skilled in the art. Examples of a suitable CPU can include an Intel Pentium® class processor, an IBM PowerPC® class processor or an AMD Athlon® class processor. The fixed storage 26 can store therein each of an operating system, for example Microsoft Windows NT® or Debian Linux (not shown), and a hypermedia document server 28 that can process requests for hypermedia documents stored in the fixed storage 26. In the preferred embodiment, the hypermedia document server 28 is a Web server. More particularly, the Web server is the Internet Information Server® manufactured by Microsoft Corporation of Redmond, Washington. Still, other Web servers can suffice, for example the open source Apache Web Server.

The fixed storage 26 can further store therein a database of music related products 24 which can be distributed on-line through suitable Web pages defining an e-commerce site. Finally, the fixed storage 26 can store a computer program or programs for performing the method for on-line distribution of music related items 100 stored in the database 24. The method for on-line distribution of music related items 100 can be implemented by a programmer of ordinary skill in the art by employing well-known Web programming methods, for example methods relating to the active server pages (ASP) technology. Those methods can be implemented and incorporated into the method for on-line distribution of music related items 1 00 using commercially available development tools for the operating systems described above.

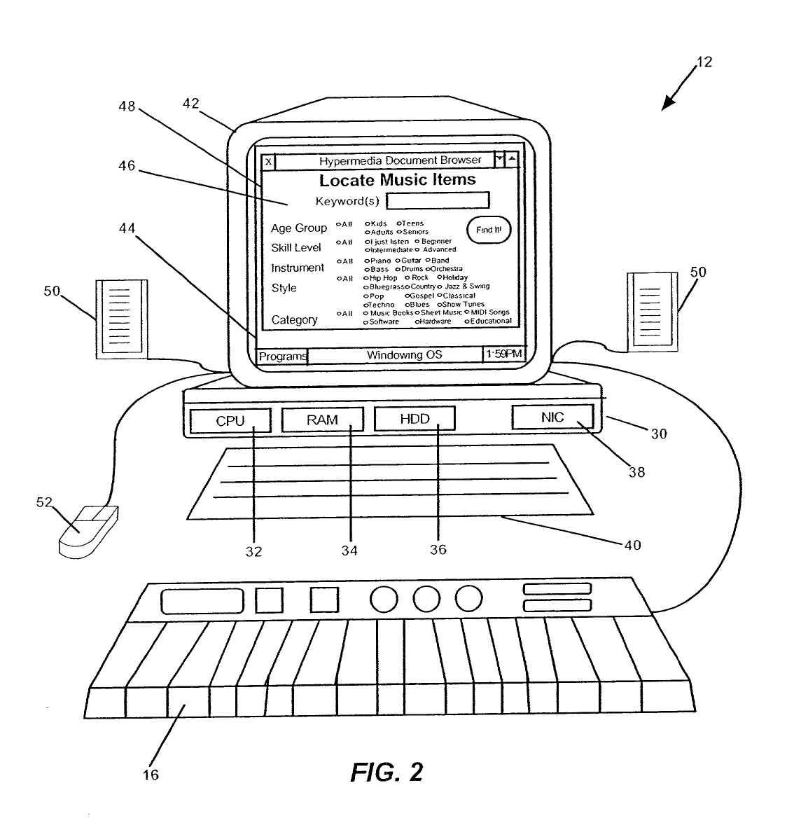

Turning now to FIG. 2, similar to the server 14, clients 12 also preferably comprise a computer 30 having a CPU 32, an internal memory device 34, fixed storage 36, and network interface circuitry 38, substantially as described above. In the preferred embodiment, the client 12 is an electronic musical instrument. Hence, optionally, the client 12 can further include a music interface 1 6, for example a keyboard, at least one user interface display unit 42, such as a video display terminal (VDT) operatively connected thereto for the purpose of interacting with the client 12, and speakers 50 for audibly presenting music to the user. Additionally, the client 12 can further include a keyboard 40 and pointing device 52. However, the invention is not limited in this regard. Rather, the client 1 2 requires neither a keyboard, pointing device, nor a VDT in order to suitably operate according to the inventive arrangements.

As in the case of the server 14, the CPU 32 can comprise any suitable microprocessor or other electronic processing unit, as is well known to those skilled in the art. Examples of a suitable CPU can include an Intel Pentium class processor, an IBM PowerPC class processor or an AMD Athlon class processor.

The fixed storage 36 can store therein each of an operating system 44 and a hypermedia document browser application 48 for displaying hypermedia documents 46, for example Web pages. Preferably, both the operating system 44 and the hypermedia document browser application 48 can be loaded into the internal memory device 34 upon initialization. The hypermedia document browser application 48 preferably permits the client 12 to send and receive requests for hypermedia documents 46 to and from the servers 14 via the computer communications network 10. In the preferred embodiment, the hypermedia document browser application 48 can be a Web browser, for example Netscape Communicator® or Microsoft Internet Explorer®.

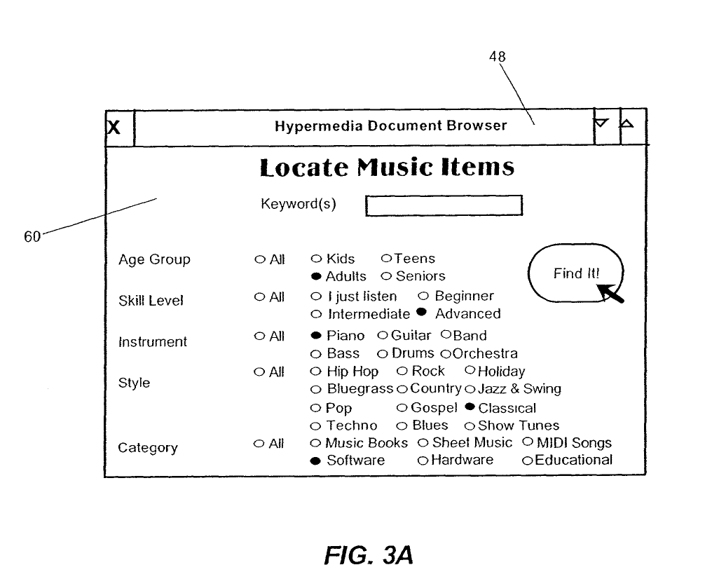

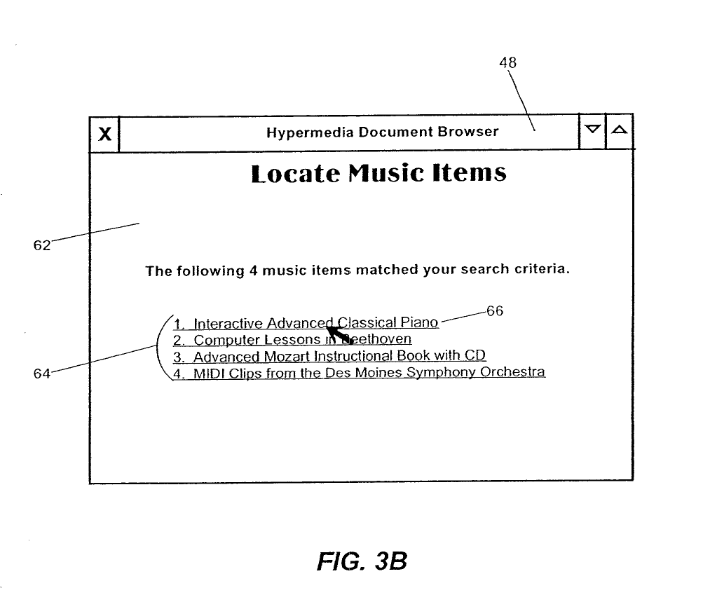

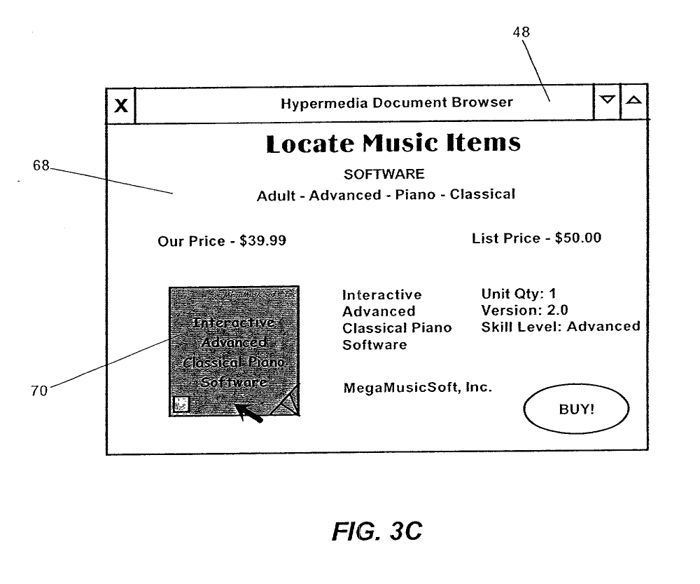

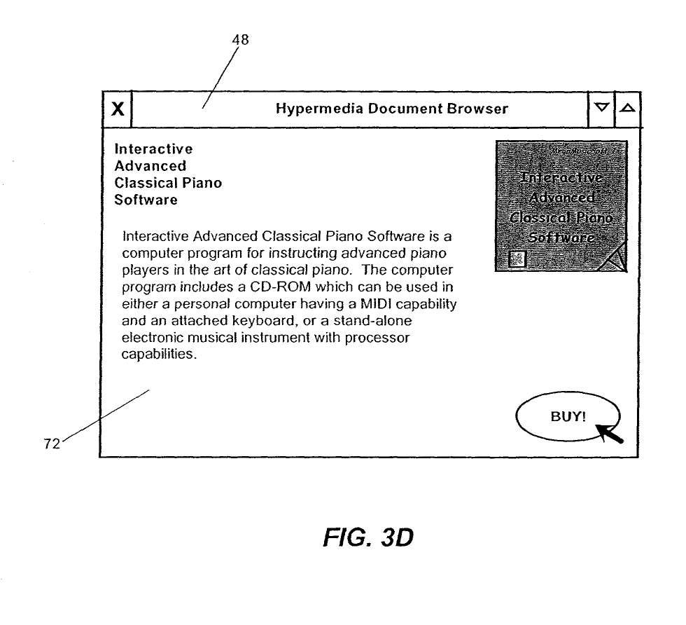

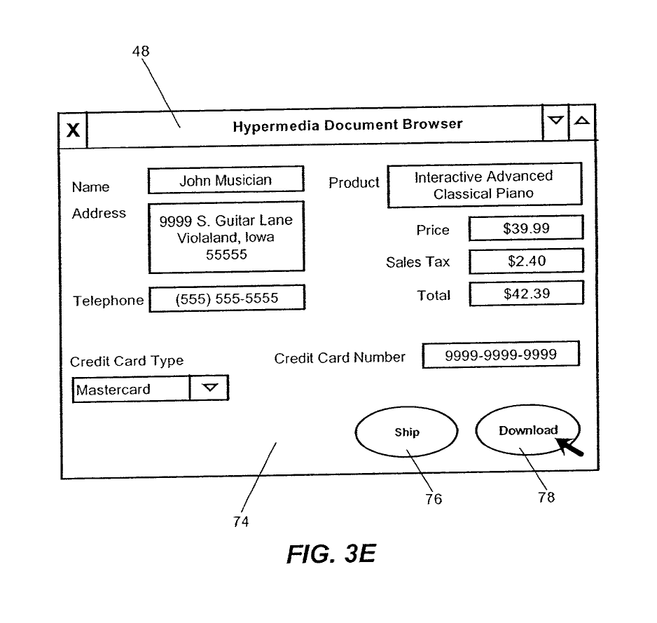

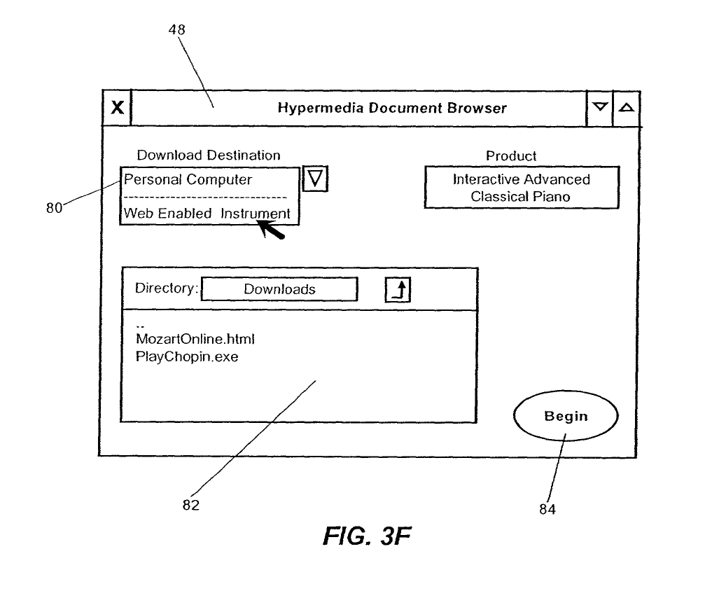

FIGS. 3A-3F are screen shots illustrating various hypermedia documents used in a method for on-line distribution of music related items. Beginning in FIG. 3A, a consumer can point the hypermedia document browser 48 to an e-commerce site having a program or programs for performing the method of on-line distribution of music related items 100. Specifically, a consumer can provide to the hypermedia document browser application 48 a uniform resource locator (URL) identifying the domain and location therein of a home Web page for the specified e-commerce site. Upon providing the URL to the hypermedia document browser application 48, a request for the home Web page can be transmitted from the client 12 to the hypermedia document server 28 in the server 14. If available, the hypermedia document server 28 can respond to the request of the hypermedia document browser application 48 by transmitting to the client 12 the requested Web page. The Web page displayed in the hypermedia document browser application 48 as shown in FIG. 3A is representative of a first hypermedia document 60 to be displayed in the requested e-commerce site.

As is apparent from the figure, in the first hypermedia document 60, the consumer is prompted to supply information defining the consumer's musical profile. Specifically, the first hypermedia document 60 can identify the consumer's age group, skill level, instrument played, and preferred music style. Moreover, the first hypermedia document 60 can identify the preferred type of product to be purchased by the consumer. Still, the invention is not limited in this regard. Rather, any other data regarding the consumer's musical profile can be collected and used to filter music related items so long as the data relates to the consumer's musical profile. For illustrative purposes only, FIG. 3A depicts the consumer being identified as an Adult who is an advanced player of a piano who prefers classical music style and is interested in purchasing music software.

Upon clicking “Find It!” in the first hypermedia document 60, the consumer's musical profile can be “posted” to the hypermedia document server 28. Specifically, the data provided to the first hypermedia document 60 by the consumer can be included in a hypertext transfer protocol (HTTP) response and transmitted to the hypermedia document server 28 upon the consumer clicking the “Find It!” button. Subsequently, the hypermedia document server 28 can both extract from the response the data in order to identify the consumer's musical profile and pass the data to the method for on-line distribution of music related items 100.

Using the extracted data, the method 1 00 can generate a database query for filtering from the database 24 only those music related items which are consonant with the consumer's musical profile. The query can be any suitable query capable of extracting a result set of data from a database, for example a structured query language (SQL) statement. Upon receiving the query, the database 24 can generate a result set of data containing only those music related items in the database 24 which relate to the consumer's musical profile. Subsequently, the database 24 can communicate the result to the method 100.

FIG. 3B illustrates a second hypermedia document 62 listing those music related items 64 included the result set. With regard to the consumer's illustrative musical profile, it is clear from the list that those musical items relate to advanced instructional software for classical piano. The second hypermedia document 62 can be transmitted from the hypermedia document server 28 to the hypermedia document browser application 48 in the client 12. Notably, the second hypermedia document 62 can be dynamically generated by the hypermedia document server 28 to include hyperlinks for each listed item. Each hyperlink can link the consumer to a hypermedia document containing further descriptive information regarding a music related item associated with the selected hyperlink. For exemplary purposes only, the consumer is shown in FIG. 3B to have selected the product “Interactive Advanced Classical Piano” 64.

As shown in FIG. 3C, upon selecting a listed product, a third hypermedia document 68 can be provided by the hypermedia document server 28. Specifically, the third hypermedia document 68 can display additional information regarding the selected music related item. The third hypermedia document 68 can provide the consumer with the option to view further information regarding the selected music related item. Alternatively, the consumer can choose to consummate the purchase of the music related item by selecting the “Buy!” button. Notably, the term “Buy!” as used in the Buy! button is merely exemplary of the type of button used to indicate a consumer's intention to purchase an item. If the consumer selects to view further information by clicking on the hyperlink 70, the hypermedia document server 48 can provide the further information.

FIG. 3D illustrates the case where the consumer elects to view further information. In that case, the further information can be displayed in a fourth hypermedia document 72. As in the case of the third hypermedia document 68, the consumer can elect to purchase the selected music related item by clicking the “Buy!” button. Upon clicking the “Buy!” button, the consumer can be presented with a hypermedia document 74 for consummating the purchase of selected music related items. As shown in FIG. 3E, the consumer can provide in the hypermedia document 74 shipping payment, billing and shipping information.

Advantageously, rather than merely shipping selected music related products to the consumer, the method 100 permits the consumer to optionally download selected music related software directly to the client 12. The consumer can elect the download option by clicking the download button 78. Otherwise, the consumer can elect to ship selected music related items to the specified shipping address by clicking the ship button 76.

FIG. 3F illustrates the circumstance where the consumer has elected to download music related software to the client 12. As shown in the figure, the consumer can specify in drop down box 80 a download destination which can include either a personal computer or a network enabled electronic musical instrument. Still, the invention is not limited in regard to the download destination. Rather, any network enabled device can be a suitable download destination. The consumer can further specify in directory browser 82 a preferred location in the client 12 for storing the selected music related software. Finally, upon clicking on the “Begin” button 84, the method 100 can transmit the selected music related software to the client 1 2 using file transfer techniques well known in the art, for example FTP. Hence, unlike traditional e-commerce systems, the method of the invention 100 permits the downloading of selected music related software directly to an electronic musical instrument.

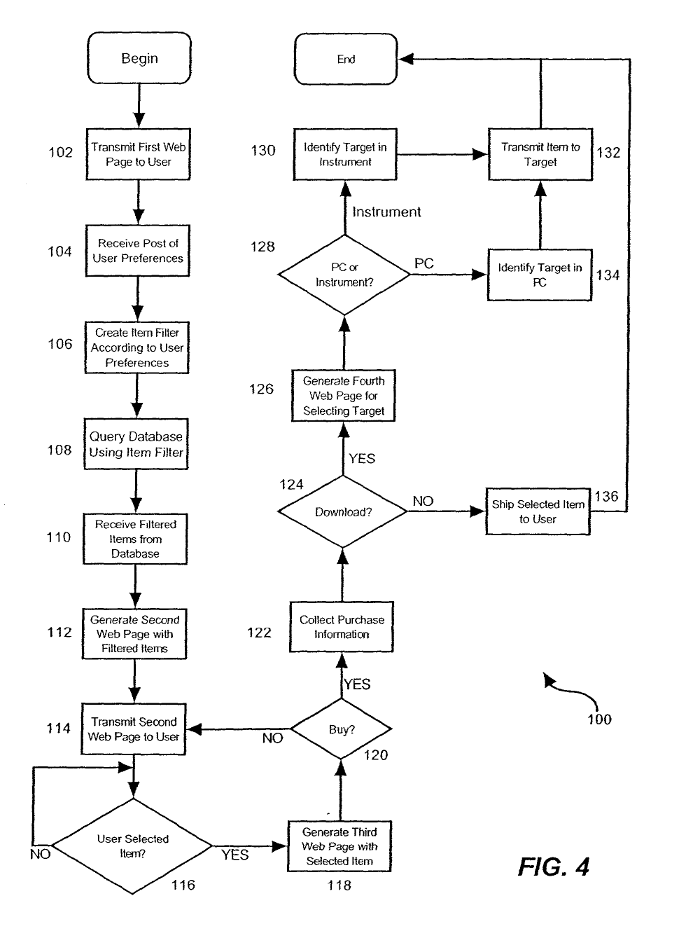

FIG. 4 illustrates a method for on-line distribution of music related items 100. The method of the invention begins in step 102 in which a first Web page can be transmitted to the consumer. The first Web page can be substantially in accordance with the Web page illustrated in FIG. 3A. In step 104, the method 100 can receive data indicating the consumer's musical profile and provided by the consumer in the first Web page and posted to the server. In step 106, the method 100 can create a music related item filter corresponding to the musical profile of the consumer as indicated in the received data. In step 108, the method 100 can query the database using the created filter.

Upon receiving a query, the database can generate a result set of music related items stored in the database and can return the result set to the method 100. Thus, in step 1 10, the method 100 can receive from the database the result set containing music related items consonant both with the query and, correspondingly, the consumer's musical profile. Upon receiving the result set, in step 112 the method 1 00 can generate a second Web page containing activated hyperlinks to individual Web pages, each individual Web page containing detailed information describing a corresponding music related item. Subsequently, in step 114, the second Web page can be transmitted to client thereby displaying to the consumer all music related items matching the consumer's musical profile.

In decision step 1 1 6, the method 1 00 can loop until the consumer selects a listed music related item for purchase. Upon selecting a music related item for purchase, in step 1 18, the method 100 can generate a third Web page containing a description of the selected item. Notably, the third Web page can be either dynamically generated, or merely retrieved as a pre-programmed Web page. In either case, the third Web page can be provided to the client for viewing by the consumer in the same manner as the first and second Web pages.

In decision step 120, if the consumer elects to buy the selected music related item, in step 122, the method 100 can collect purchase information including, but not limited to a billing address, shipping address and credit card information. Otherwise, if the consumer elects not to purchase the selected item, the method 100 can branch to step 1 14 upon which the method 100 can retransmit the second Web page to the client.

Upon collecting purchase information, the consumer optionally can choose to download selected music related software rather than requesting shipment of the same. In decision step 1 24, if the consumer elects to ship rather than download, the method 1 00 can branch to step 1 36 in which case the selected music related items can be shipped to the consumer thereby consummating the transaction. Otherwise, if in step 1 24 the consumer elects to download rather than ship, in step 126 a fourth Web page can be generated in which the consumer can select a suitable target for the downloaded items.

In particular, in step 128, preferably the consumer can select from a personal computer or network enabled musical instrument. However, the invention is not limited in this regard. Rather, the consumer can elect to download to any suitable network enabled device, for example a handheld device. In step 130, if the consumer has selected a network enabled electronic musical instrument as a target device, the consumer can further identify a particular location in the network enabled electronic musical instrument to which the selected music related software can be downloaded. Likewise, in step 134, if the consumer has selected a personal computer as a target device, the consumer can further identify a particular location in the personal computer to which the selected music related software can be downloaded. In either case, in step 132 the selected music related software can be downloaded to the target location in the target, subsequent to which the method 100 terminates.

The spirit of the present invention is not limited to any embodiment described above. Rather, the details and features of an exemplary embodiment were disclosed as required. Without departing from the scope of this invention, other modifications will therefore be apparent to those skilled in the art. Thus, it must be understood that the detailed description of the invention and drawings were intended as illustrative only, and not by way of limitation.

1. A method for on-line distribution of music related items comprising the steps of:
identifying a musical profile of a consumer in a first interactive hypermedia document;
responsive to said identification, listing in a second interactive hypermedia document music related items consonant with said identified musical profile;
accepting in said second interactive hypermedia document a user selection of at least one of said music related items; and,
consummating a purchase of said at least one selected music related item.

2. The method according to claim 1, wherein said identifying step comprises the step of:
classifying said consumer according to age and instrument played.

3. The method according to claim 1, wherein said identifying step comprises the step of:
classifying said consumer according to age and skill level.

4. The method according to claim 1, wherein said identifying step comprises the step of:
classifying said consumer according to age and preferred music type.

5. The method according to claim 1, wherein said identifying step comprises the step of:
classifying said consumer according to instrument played and skill level.

6. The method according to claim 1, wherein said identifying step comprises the step of:
classifying said consumer according to instrument played and preferred music type.

7. The method according to claim 1, wherein said identifying step comprises the step of:
classifying said consumer according to skill level and preferred music type.

8. The method according to claim 1, wherein said identifying step comprises the step of:
classifying said consumer according to age, instrument played, skill level and preferred music type.

9. The method according to claim 8, wherein said identifying step comprises the step of:
further classifying said consumer according to type of music related item.

10. The method according to claim 1, wherein said identifying step comprises the steps of:
transmitting said first interactive hypermedia document from a server to a client;
accepting in said client a consumer selection in said first interactive hypermedia document; and,
posting said selection from said client to said server.

11. The method according to claim 10, wherein said posting step comprises the step of:
including said selection in a hypertext transfer protocol response.

12. The method according to claim 1, wherein said listing step comprises the steps of:
generating a query statement for a database of music related items, said query statement generated using said identified musical profile;
performing an electronic query of said database using said query statement;
retrieving a result set from said database, said result set containing a listing of at least one music related item filtered from said database using said query statement;
inserting each said listing in said result set in said second interactive hypermedia document, each said listing hyperlinked to a hypermedia document further describing said music related item; and,
transmitting said second hypermedia document from a server to a client.

13. The method according to claim 1, further comprising the steps of:
responsive to said user selection of at least one music related item in said second interactive hypermedia document, providing a third interactive hypermedia document further describing said music related item; and,
accepting in said third interactive hypermedia document a user command for purchasing said at least one music related item.

14. The method according to claim 13, wherein said third interactive hypermedia document contains a hyperlink to a fourth interactive hypermedia document for displaying detailed information describing said at least one music related item.

15. The method according to claim 1, wherein said consummating step comprises the steps of:
accepting a consumer selection for downloading said at least one selected music related item to a client;
identifying a target location in said client for downloading said at least one selected music related item; and
transmitting said at least one selected music related item to said target location in said client.

16. The method according to claim 15, wherein said client is a network-enabled electronic musical instrument.
